(19) United States
(12) Patent Application Publication
(10) Pub. No.: US 2011/0192673 A1
(43) Pub. Date: Aug. 11, 2011

(54) VEHICLE STEERING MECHANISM AND ASSEMBLY THEREOF

(75) Inventors: Brian C. Coleman, Shelby Township, MI (US); George E. Doerr, Clarkson, MI (US)

(73) Assignee: GM GLOBAL TECHNOLOGY OPERATIONS, INC., Detroit, MI (US)

(21) Appl. No.: 12/703,333

(22) Filed: Feb. 10, 2010

(51) Int. Cl. B62D 3/00; B62D 7/22; B23P 11/00

(52) U.S. Cl. 180/400; 29/428

(57) ABSTRACT

A steering mechanism includes a steering gear housing and a first mounting bracket fixedly attached thereto. A second mounting bracket is mounted with respect to the steering gear housing and configured with flexible and fixed states. The flexible state has a first degree of freedom between the steering gear housing and the second mounting bracket, and the fixed state has no degrees of freedom. A locking element adjusts the second mounting bracket between the flexible state and the fixed state. The flexible state of the steering mechanism may further include a second degree of freedom between the steering gear housing and the second mounting bracket. The first degree of freedom may allow translational movement substantially parallel to an axis of the steering gear housing, and the second degree of freedom may allow rotational movement substantially about the axis.

### TECHNICAL FIELD

This disclosure relates to attachment of steering mechanisms to vehicles.

### BACKGROUND OF THE INVENTION

Steering systems for vehicles allow the operator or driver to turn the vehicle by turning a steering wheel or similar component which turns the wheels of the vehicle. Power steering systems assist the driver in steering the motor vehicle by providing additional force to the steering motion at the wheels. Loads are transferred from the steerable wheels to a frame or chassis of the vehicle, allowing the whole vehicle to turn based upon the command from the driver.

A hydraulic power steering system employs an engine-driven hydraulic power steering pump for generating pressurized fluid that is coupled to a hydraulic steering gear of the motor vehicle. Electrohydraulic power steering systems may be used to decouple the power steering pump from the engine and provide on-demand hydraulic pressure using an electric motor to drive the hydraulic power steering pump. Electrically driven power steering systems operate without using any hydraulic fluids.

### SUMMARY

A steering mechanism for a vehicle is provided. The steering mechanism includes a steering gear housing and a first mounting bracket fixedly attached thereto. A second mounting bracket is mounted with respect to the steering gear housing and is configured with a flexible state and a fixed state. The flexible state has a first degree of freedom between the steering gear housing and the second mounting bracket, but the fixed state has no degrees of freedom between the steering gear housing and the second mounting bracket. A locking element is mounted with respect to the second mounting bracket and is configured to adjust the second mounting bracket between the flexible state and the fixed state.

The flexible state of the steering mechanism may further include a second degree of freedom between the steering gear housing and the second mounting bracket. The first degree of freedom may allow translational movement substantially parallel to an axis of the steering gear housing, and the second degree of freedom may allow rotational movement substantially about the axis.

A method of assembling a steering mechanism to a vehicle frame includes rigidly attaching a hard-mount bracket to a steering gear housing, such that the hard-mount bracket has no degrees of freedom relative to the steering gear housing. A flexible-mount bracket is loosely attached to the steering gear housing, such that the flexible-mount bracket has at least one degree of freedom relative to the steering gear housing. The hard-mount bracket is aligned to a first coupling on the vehicle frame and attached to the first coupling. The flexible-mount bracket is aligned to a second coupling on the vehicle frame and attached to the second coupling. The flexible-mount bracket is then rigidly attached to the steering gear housing, removing at least one degree of freedom of the flexible-mount bracket relative to the steering gear housing.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic isometric view of a portion of a vehicle frame and a steering mechanism;

FIG. 2 is a schematic isometric view of a flexible-mount bracket having two temporary degrees of freedom; and

FIG. 3 is a schematic flow chart diagram of a method or algorithm for assembling a vehicle steering mechanism.

### DESCRIPTION OF PREFERRED EMBODIMENTS

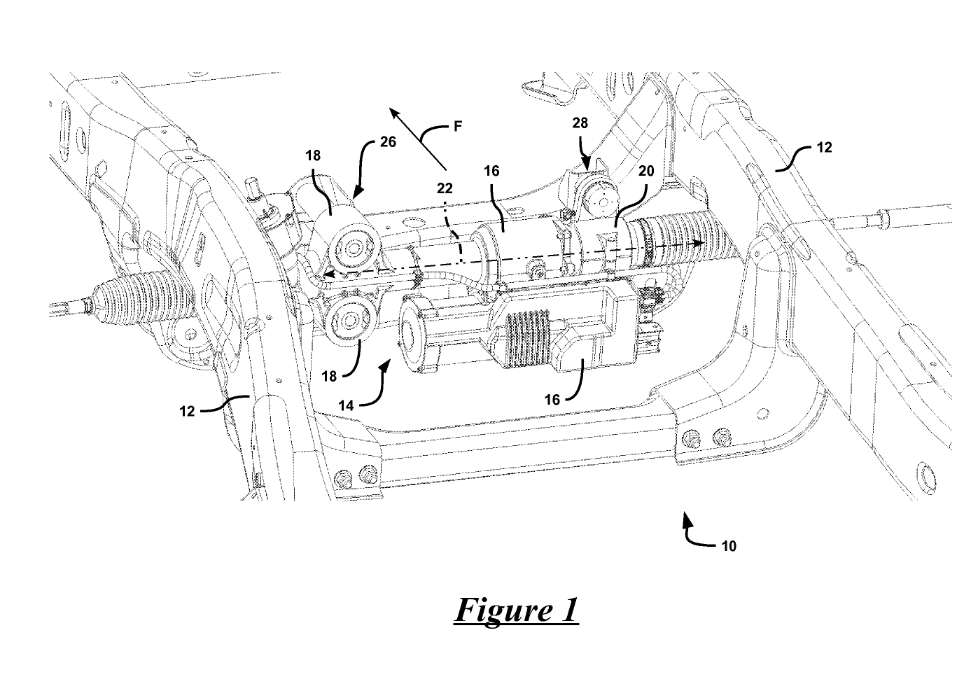

Referring to the drawings, wherein like reference numbers correspond to like or similar components throughout the several figures, there is schematically shown in FIG. 1 a portion of a vehicle 10. The vehicle 10 includes a vehicle frame or chassis 12 (only partially shown) to which a steering mechanism 14 is mounted or ready for assembly. The chassis 12 shown may generally be referred to as a body-on-frame or ladder frame. However, the steering mechanism 14 may be attachable to a unibody, body frame integral, monocoque, or similar vehicle structure. Furthermore, the steering mechanism 14 may also be attachable to a sub frame portion of either a unibody or body-on-frame chassis 12.

While the present invention is described in detail with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims.

The steering mechanism 14 translates directional signals (usually from a steering wheel in the cabin) from the operator of the vehicle 10 into movement of the steerable wheels (not shown, usually the front wheels) of the vehicle 10. The steering mechanism 14 may be, without limitation, a hydraulic power steering system, an electric power steering system, an electro-hydraulic power steering system, a manual steering system, or other steering systems utilizing a rack and pinion steering gear. As shown in FIG. 1, the steering mechanism 14 includes a steering gear housing 16. The steering mechanism 14 is configured to be assembled to the chassis 12 with mounting structures attached or affixed to the steering gear housing 16.

A first mounting bracket 18 is fixedly attached to the left side of the steering gear housing 16, as viewed in FIG. 1. A second mounting bracket 20 is mounted on the right side of the steering gear housing 16, as viewed in FIG. 1. Either of the mounting bracket 18 or the mounting bracket 20 may be referred to as the first or the second mounting bracket.

In the configuration shown in FIG. 1, the front of the vehicle 10 and the direction of forward travel are represented by an arrow F. Therefore, the left and right sides of FIG. 1 correspond to the driver and passenger sides, respectively, of the vehicle 10 if the vehicle 10 is a left-hand drive vehicle. However, the mounting bracket 18 need not necessarily be located on the left side and the mounting bracket 20 need not necessarily be located on the right side. Furthermore, the steering mechanism 14 may be utilized in other vehicles, such as, without limitation: right-hand drive vehicles, heavy and construction equipment, and vehicles having center-drive configurations.

The mounting bracket 18 may be referred to as a hard-mount bracket. In the configuration shown in FIG. 1, the mounting bracket 18 is integrally formed as a single, unitary piece with the steering gear housing 16. However, the mounting bracket 18 may be a separate component which is then rigidly and fixedly mounted to the steering gear housing 16.

The mounting bracket 20 may be referred to as a flexible-mount bracket and is configured with both a flexible state and a fixed state. In the flexible state, there is at least one degree of freedom, a first degree of freedom, between the steering gear housing 16 and the mounting bracket 20. However, in the fixed state, there are no degrees of freedom between the steering gear housing 16 and the mounting bracket 20, such that the position of the steering gear housing 16 is fixed relative to the chassis 12.

A steering rack (not shown) is located within the steering gear housing 16 and an axis 22 of the steering gear housing 16 is substantially parallel to the rack, which may be of multi-piece construction. While in the flexible state, the first degree of freedom allows translational movement of the mounting bracket 20 relative to the steering gear housing 16 substantially parallel to the axis 22. The mounting bracket 20 may be further configured with a second degree of freedom allowing rotational movement of the mounting bracket 20 substantially about the axis 22 relative to the steering gear housing 16.

As shown in FIG. 1, the chassis 12 includes a first the coupling 26 and a second the coupling 28 to accept attachment of the steering mechanism 14. The mounting bracket 18 is configured to mate to the coupling 26 and the mounting bracket 20 is configured to mate to the coupling 28. Either of the coupling 26 or the coupling 28 may be referred to as the first or the second coupling.

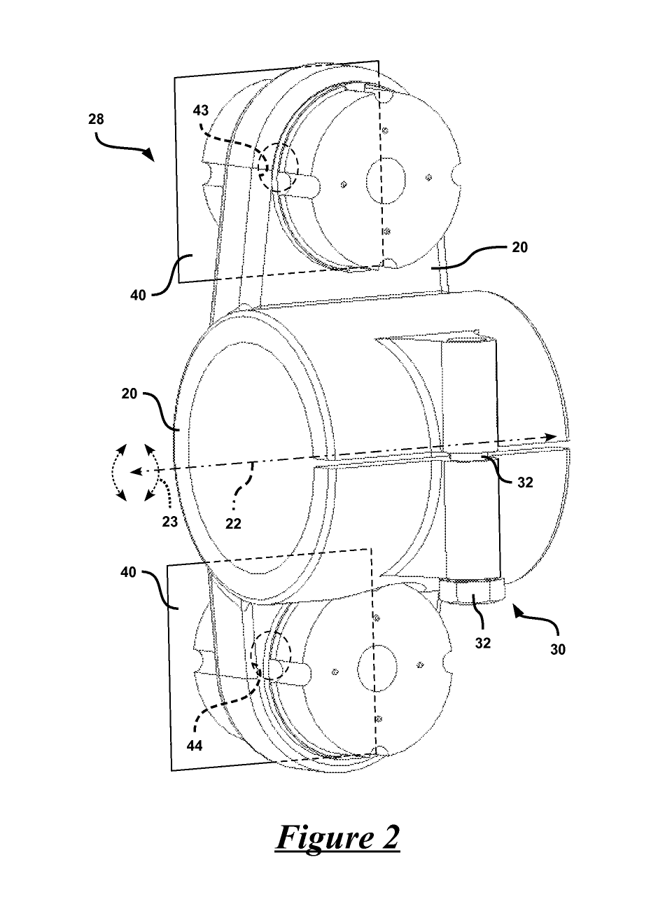

Referring now to FIG. 2, and with continued reference to FIG. 1, there is shown a schematic isometric view of the mounting bracket 20. The steering gear housing 16 is attached to the coupling 26 and the coupling 28 of the chassis 12 with, for example, threaded fasteners.

After the mounting bracket 18 is mated to the coupling 26 and the mounting bracket 20 is mated to the coupling 28, the mounting bracket 20 is adjusted from the flexible state to the fixed state, thereby removing or locking out the first and second degrees of freedom. A locking element 30 is configured to provide the adjustment of the mounting bracket 20 between the flexible state and the fixed state. In the configuration of the mounting bracket 20 shown in FIG. 1, the locking element 30 is a pinch bolt 32. However, the locking element 30 may be any other component or device configured to adjust the mounting bracket 20 between the flexible state and the fixed state.

The coupling 26 of the chassis 12 has a first mounting surface (largely hidden from view by the mounting bracket 18 in FIG. 1, not shown in FIG. 2) with first and second fixed anchor points (hidden from view in FIG. 1). The coupling 28 has a second mounting surface 40 with third and fourth fixed anchor points 43, 44. Either of the mounting surfaces on the coupling 26 or the coupling 28 may be interchangeably referred to as the first or second mounting surface. The anchor points may be threaded holes, bores, or other receptacles configured to allow load transfer between the steering mechanism 14 and the chassis 12.

In order to mate the steering gear housing 16 to the chassis 12, the mounting bracket 18 must substantially align to mounting surface of the coupling 26. The mounting surface may be a continuous plane, multiple planes, or other shapes configured to mate with a portion of the mounting bracket 18. The first and second anchor points must also substantially align with respective mounting holes in the mounting bracket 18. Otherwise, the threaded fasteners may not be aligned and may not be attachable to the first and second anchor points.

Similarly, the mounting bracket 20 must substantially align to mounting surface 40 of the coupling 28. The mounting surface 40 may also be a continuous plane, multiple planes, or other shapes (such as cones or partial spheres) configured to mate with a portion of the mounting bracket 20. The third and fourth fixed anchor points 43, 44 must also substantially align with respective mounting holes in the mounting bracket 20.

While in the flexible state, the first degree of freedom of the mounting bracket 20 allows movement along the axis 22 (left and right, roughly, as viewed in FIG. 2). Manufacturing variations may result in difficult assembly if the expected relationships between couplings 26, 28 and mounting brackets 18, 20 are not held to very high tolerances. The first degree of freedom allows for manufacturing variations in the chassis 12 and steering gear housing 16 which result in differences between the coupling 26 and the coupling 28 relative to the mounting bracket 18 and the mounting bracket 20.

Furthermore, the second degree of freedom of the mounting bracket 20 allows rotation about the axis 22, which is shown by arrows 23. This second degree of freedom also allows for manufacturing variations in the chassis 12 and steering gear housing 16. The second degree of freedom adjusts for variations in mounting surface and second mounting surface 40. The first and second degrees of freedom allow the steering gear housing 16 to be assembled to the chassis 12 in spite of significant manufacturing variations.

Once the first and second degrees of freedom have been utilized to mate the mounting bracket 18 to the coupling 26 and the mounting bracket 20 to the coupling 28, the mounting bracket 20 is adjusted from the flexible state to the fixed state. To adjust the mounting bracket 20 to the fixed state, the locking element 30 may be closed or tightened. In addition to the pinch bolt 32 shown in FIG. 2, other usable locking mechanisms may include, without limitation: a plurality of pinch bolts; set screws or blind set screws (possibly cooperating with a D-flat on steering gear housing 16); threaded fasteners cooperating with a receptacle in the steering gear housing 16; a dowel and matching receptacle in the steering gear housing 16; or other devices recognizable to those having ordinary skill in the art.

In the fixed state, the mounting bracket 20 provides substantially rigid load transfer between the steering gear housing 16 and the mounting bracket 20. Therefore, the fixed state may act or respond as if the mounting bracket 20 was formed as a unitary piece of the steering gear housing 16. The mounting bracket 18 and the mounting bracket 20 may further include one or more bushings. Note, however, that any flexibility provided by bushings is consistent from pre-assembly through final assembly, and is not altered by adjusting the mounting bracket 20 between the flexible state and fixed state.

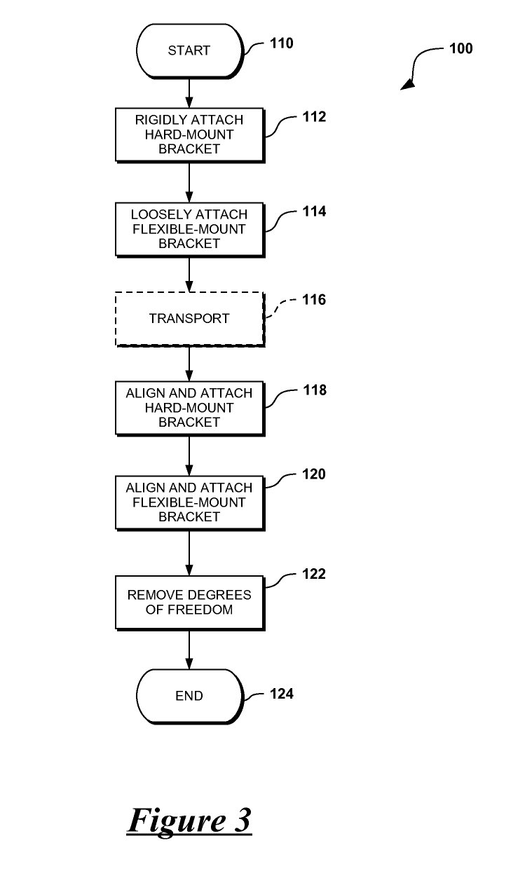

Referring now to FIG. 3, and with continued reference to FIGS. 1 and 2, there is shown an algorithm or method 100 for assembling a vehicle steering mechanism. The method 100 may be utilized with some, or all, of the structure illustrated in FIGS. 1-2. However, the method 100 may also be incorporated into other vehicle and powertrain arrangements, control schemes, or control structures, and has applicability beyond the components schematically illustrated in FIGS. 1-2.

The method 100 is shown as a schematic flow chart. The exact order of the steps of the method 100 shown in FIG. 3 is not required. Steps may be reordered, steps may be omitted, and additional steps may be included. The method 100 is a basic, illustrative method of assembling a vehicle steering mechanism (such as the steering mechanism 14 shown and described herein) to a chassis (such as the vehicle frame or chassis 12), but may be supplemented with additional features recognizable to those having ordinary skill in the art.

Method 100 begins at an initiation or start step 110, which may include setup or preparation of the assembly area or areas, manufacture of some of the components utilized in the method 100, or other initial processes recognizable to those having ordinary skill in the art.

At step 112 a hard-mount bracket (such as the mounting bracket 18) is rigidly attached to a steering gear housing (such as the steering gear housing 16), such that the hard-mount bracket has no degrees of freedom relative to the steering gear housing. This attachment step may include manufacturing the hard-mount bracket as a unitary, one-piece structure with the steering gear housing, or may include separately manufacturing and then mating the two components with a fixed relationship to each other.

At step 114, a flexible-mount bracket (such as the mounting bracket 20) is loosely attached to the steering gear housing, such that the flexible-mount bracket has at least one degree of freedom relative to the steering gear housing. The flexible-mount bracket may be configured to have at least two degrees of freedom relative to the steering gear housing. Loosely attaching the flexible-mount bracket allows the steering gear housing to be supported by the flexible-mount bracket for movement and assembly of the steering gear housing. Following step 114, the steering mechanism may be completely assembled, or may have additional components (such as tie rods or electrical connections) requiring subsequent assembly.

The steering mechanism, with the hard-mount bracket and flexible-mount bracket may then be moved or transported in an optional step 116. The steering mechanism may be assembled in one facility and then transported to another facility, or may simply be moved between different areas of the same manufacturing or assembly facility. Alternatively, the chassis may be transported to the location of the steering mechanism.

At step 118, the hard-mount bracket is aligned to a first coupling (such as the coupling 26) on the chassis, and then the hard-mount bracket attached to the first coupling. The hard-mount bracket and the first coupling may be on the driver side of the final vehicle. At step 120 the flexible-mount bracket is aligned to a second coupling (such as the coupling 28) on the chassis, and then the flexible-mount bracket attached to the second coupling. Attachment of both brackets to the chassis completes mating of the steering gear housing to the chassis.

At step 122 the flexible-mount bracket is rigidly attached to the steering gear housing by adjusting a locking element or clasp (such as the locking element 30 or, in one embodiment, the pinch bolt 32). This removes the degrees of freedom (at least one, but possibly two or more) of the flexible-mount bracket relative to the steering gear housing and allows substantially rigid load transfer between the steering gear housing and the chassis. End step 124 may include moving the chassis and steering mechanism to another facility or elsewhere within the same facility for further assembly of the vehicle.

While the best modes and other embodiments for carrying out the claimed invention have been described in detail, those familiar with the art to which this invention relates will recognize various alternative designs and embodiments for practicing the invention within the scope of the appended claims.

1. A steering mechanism, comprising:
a steering gear housing;
a first mounting bracket fixedly attached to the steering gear housing;
a second mounting bracket mounted with respect to the steering gear housing, configured with a flexible state and a fixed state;
wherein the flexible state has a first degree of freedom between the steering gear housing and the second mounting bracket;
wherein the fixed state has no degrees of freedom between the steering gear housing and the second mounting bracket; and
a locking element mounted with respect to the second mounting bracket and configured to adjust the second mounting bracket between the flexible state and the fixed state.

2. The mechanism of claim 1, wherein the flexible state has a second degree of freedom between the steering gear housing and the second mounting bracket.

3. The mechanism of claim 2,
wherein the steering gear housing has an axis;
wherein the first degree of freedom allows translational movement substantially parallel to the axis; and
wherein the second degree of freedom allows rotational movement substantially about the axis.

4. The mechanism of claim 3, further comprising:
a steering rack disposed within the steering gear housing, wherein the axis of the steering gear housing is substantially coincident to the steering rack.

5. The mechanism of claim 4, wherein the steering mechanism is configured to be attachable to a vehicle frame at a first coupling and a second coupling, such that the first mounting bracket mates to the first coupling and the second mounting bracket mates to the second coupling.

6. The mechanism of claim 5, wherein the first coupling has a first mounting surface with first and second fixed anchor points, and wherein the second coupling has a second mounting surface with third and fourth fixed anchor points.

7. The mechanism of claim 6,
wherein the first and second fixed anchor points accept first and second threaded fasteners, such that the first and second threaded fasteners attach the first mounting bracket to the first coupling at the first mounting surface; and
wherein the third and fourth fixed anchor points accept third and fourth threaded fasteners such that the third and fourth threaded fasteners attach the second mounting bracket to the second coupling at the second mounting surface.

8. The mechanism of claim 7, wherein the locking element is a pinch bolt.

9. A method of assembling a steering mechanism to a vehicle frame, comprising:
rigidly attaching a hard-mount bracket to a steering gear housing, such that the hard-mount bracket has no degrees of freedom relative to the steering gear housing;
loosely attaching a flexible-mount bracket to the steering gear housing, such that the flexible-mount bracket has at least one degree of freedom relative to the steering gear housing;
aligning the hard-mount bracket to a first coupling on the vehicle frame;
attaching the hard-mount bracket to the first coupling;
aligning the flexible-mount bracket to a second coupling on the vehicle frame;
attaching the flexible-mount bracket to the second coupling; and
rigidly attaching the flexible-mount bracket to the steering gear housing and removing the at least one degree of freedom of the flexible-mount bracket relative to the steering gear housing.

10. The method of claim 9,
wherein loosely attaching the flexible-mount bracket to the steering gear housing includes allowing the flexible-mount bracket to have at least two degrees of freedom relative to the steering gear housing; and
wherein rigidly attaching the flexible-mount bracket to the steering gear housing includes removing the at least two degrees of freedom relative to the steering gear housing.

11. The method of claim 10, wherein rigidly attaching the hard-mount bracket to the steering gear housing includes integrally forming the hard-mount bracket and the steering gear housing as one unitary piece.

12. The method of claim 11, wherein the hard-mount bracket is aligned and attached to a driver side of the vehicle frame and the flexible-mount bracket is aligned and attached to a passenger side of the vehicle frame.

13. A steering mechanism, comprising:
a steering gear housing;
a first mounting bracket fixedly attached to the steering gear housing;
a second mounting bracket mounted with respect to the steering gear housing, configured with a flexible state and a fixed state;
wherein the flexible state has a first degree of freedom between the steering gear housing and the second mounting bracket, and a second degree of freedom between the steering gear housing and the second mounting bracket;
wherein the fixed state has no degrees of freedom between the steering gear housing and the second mounting bracket; and
a locking element configured to adjust the second mounting bracket between the flexible state and the fixed state.

14. The mechanism of claim 13, wherein the steering mechanism is configured to be attachable to a vehicle frame at a first coupling and a second coupling, such that the first mounting bracket mates to the first coupling and the second mounting bracket mates to the second coupling.

15. The mechanism of claim 14,
wherein the steering gear housing has an axis;
wherein the first degree of freedom allows translational movement substantially parallel to the axis; and
wherein the second degree of freedom allows rotational movement substantially about the axis.
